(19) United States
(12) Patent Application Publication
(10) Pub. No.: US 2026/0338248 A1
(43) Pub. Date: Oct. 29, 2026

(54) DAMPING MEDIUM FOR USE IN A DAMPER FOR A FITTING

(71) Applicant: Julius Blum GmbH, Hoechst (AT)

(72) Inventors: Jonas SUTTERLUETTI, Fussach (AT); Stefan HEUFELDER, Hoechst (AT)

(21) Appl. No.: 19/701,017

(22) Filed: Jun. 8, 2026

Related U.S. Application Data
(63) Continuation of application No. PCT/AT2024/060428, filed on Nov. 5, 2024.

(30) Foreign Application Priority Data
Dec. 12, 2023 (AT) A 50995/2023

(51) Int. Cl. F16F 9/14; A47B 88/473

(52) U.S. Cl. CPC F16F 9/14; A47B 88/473; F16F 2224/048; F16F 2226/00; F16F 2230/30

(57) ABSTRACT

A damping medium is provided for use in a damper for a fitting, preferably a furniture fitting. The damper includes a damper housing, a damping chamber for receiving the damping medium, and a piston movable relative to the damper housing within the damping chamber. The damping medium is a mixture comprising a first fluid, preferably a first liquid, and at least a second fluid, preferably a second liquid. The at least one second fluid in the form of a pure substance prior to the mixing with the first fluid has a, preferably 10 to 200,000 times, particularly preferably 100 to 10,000 times, higher zero viscosity than the first fluid in the form of a pure substance prior to the mixing with the at least one second fluid under otherwise identical conditions.

The present application is a continuation of International Application No. PCT/AT2024/060428, filed on Nov. 5, 2024. Thus, all of the subject matter of International Application No. PCT/AT2024/060428 is incorporated herein by reference.

### BACKGROUND OF THE INVENTION

The present invention relates to a damping medium according to the preamble of claim 1, as well as a damper with such a damping medium, a fitting with such a damper and/or such a damping medium, an arrangement with such a fitting and a method for producing such a damping medium.

Damping media are known from the prior art, for example from DE 40 19 150 A1. Such damping media can be used for door closers, specifically for dampened movements of a door. It is also conceivable that other objects could move in a dampened manner, such as windows, cupboard doors, panels or the like.

Damping media must overcome various challenges. Damping media should exhibit certain solubilities, emulsion stabilities, environmental compatibility, shear behavior and/or the like.

In particular, the shear behavior of a damping medium should be as ideally suited as possible to the respective application. It is important that the viscosity and shear behavior of the damping medium enable ideal damping behavior at different shear rates, while at the same time avoiding or at least reducing leakage from the damping systems.

To adjust the shear behavior of a damping medium, fillers are sometimes added, but these do not deliver the desired results.

### SUMMARY OF THE INVENTION

The object of the present invention is therefore to at least partially eliminate the disadvantages of the prior art and to provide an improved damping medium in comparison with the prior art, which is distinguished in particular by an adapted shear behavior at different shear rates. The object also consists in specifying a damper with such a damping medium, a fitting with such a damper and/or such a damping medium, an arrangement with such a fitting and a method for producing such a damping medium.

This object is achieved by a damping medium for use in a damper for a fitting, preferably a furniture fitting. The damper has a damper housing, at least one damping chamber for receiving the damping medium, and a piston movable relative to the damper housing in the damping chamber. The damping medium is a mixture comprising a first fluid, preferably a first liquid, and at least one second fluid, preferably a second liquid. The at least one second fluid in the form of a pure substance has, before mixing with the first fluid, a zero viscosity that is preferably 10 times to 200,000 times, particularly preferably 100 times to 10,000 times, higher than that of the first fluid in the form of a pure substance before mixing with the at least one second fluid under otherwise identical conditions.

The technical effect of the damping medium is that by using two fluids with significantly different zero viscosities, a desired shear behavior of the mixture can be achieved. For example, if two fluids with very similar zero viscosity are mixed, the zero viscosity and/or shear behavior of the mixture will not differ significantly from the zero viscosities and/or shear behavior of the individual fluids. By mixing these fluids, only a very limited range of the viscosity of the mixture is accessible and adjustable. In contrast, if fluids with significantly different zero viscosities are mixed, mixtures with a wide variety of zero viscosities and/or shear behavior can be produced, which are better suited for the respective desired application, preferably at different shear rates.

A fitting can be, for example, a pull-out guide with two or more rails or a hinge with two or more fitting plates.

A mixture is a substance made up of at least two pure substances.

A pure substance is a substance consisting of only one chemical compound or only one chemical element.

In this application, “viscosity”, denoted by the Greek letter η, refers to the dynamic shear viscosity of fluids, specifically liquids or gases.

In this application, “zero viscosity” η⁰ refers to the dynamic shear viscosity of fluids, specifically liquids or gases, at a shear rate of 0 s⁻¹.

The formulation that “the at least one second fluid in the form of a pure substance has, before mixing with the first fluid, a zero viscosity that is preferably 10 times to 200,000 times, particularly preferably 100 times to 10,000 times, higher than that of the first fluid in the form of a pure substance before mixing with the at least one second fluid” is explained by way of example as follows, whereby this explanatory example is only intended to serve better understanding and is not to be understood as restrictive:

A mixture AB consists of a fluid A and a fluid B, which are mixed together to produce the mixture AB. Before mixing with fluid B, fluid A is a pure substance Aₚᵤᵣₑ and has, before mixing with fluid B, a zero viscosity η_{A}⁰. Before mixing with fluid A, fluid B is also a pure substance Bₚᵤᵣₑ and has, before mixing with fluid A, a zero viscosity η_{B}⁰. The mixture AB, which is produced by mixing of pure substance Aₚᵤᵣₑ and pure substance Bₚᵤᵣₑ, has a zero viscosity η_{AB}⁰. In a damping medium according to the invention, the zero viscosity η_{B}⁰ of the pure substance Bₚᵤᵣₑ, i.e., of the at least one second fluid B in the form of a pure substance before mixing with the at least one first fluid A, must be greater, preferably 10 times to 200,000 times, particularly preferably 100 times to 10,000 times greater, than the zero viscosity η_{A}⁰ of the pure substance Aₚᵤᵣₑ, i.e., of the at least one first fluid A in the form of a pure substance before mixing with the at least one second fluid B.

The above example can also be described as follows:

If the components A and B of the mixture AB are separated from each other, i.e., exist in the form of pure substances Aₚᵤᵣₑ and Bₚᵤᵣₑ, then η_{A}⁰<η_{B}⁰, preferably [10 to 200,000]·η_{A}⁰=η_{B}⁰, particularly preferably [100 to 10,000]·η_{A}⁰=η_{B}⁰.

In the event that the damping medium is a mixture comprising more than two fluids, the invention is to be understood as meaning that the fluid within the mixture with the highest zero viscosity, in the form of a pure substance, has a zero viscosity, before mixing with the remaining fluids, that is higher, preferably 10 to 200,000 times higher, and particularly preferably 100 to 10,000 times higher, than that fluid within the mixture with the lowest zero viscosity, in the form of a pure substance, before mixing with the remaining fluids, under otherwise identical conditions.

For the purposes of this application, “otherwise identical conditions” means that the conditions for determining the viscosities η, in particular the zero viscosities of the pure substances Aₚᵤᵣₑ and Bₚᵤᵣₑ, specifically η_{A}⁰ and η_{B}⁰, are determined under the same conditions as pressure p and/or temperature T.

In other words, under otherwise identical conditions, this can mean that the zero viscosities of components A and B are each determined in the form of a pure substance before mixing, specifically the pure substances Aₚᵤᵣₑ and Bₚᵤᵣₑ, under standard conditions, i.e. 0 °°C and 100,000 Pa and/or 20 °°C and 101,325 Pa.

Under “otherwise identical conditions” other environmental influences, such as the same radiation conditions, the same electric and/or magnetic field and/or similar, can also be understood instead or additionally.

According to a preferred embodiment of the damping medium, the mixture can be a solution or a dispersion, preferably an emulsion.

A solution is a homogeneous mixture of at least two pure substances, such as two miscible fluids.

A dispersion is a heterogeneous mixture of at least two pure substances, such as a suspension on a fluid and a solid that is insoluble in it.

An emulsion is a heterogeneous mixture of at least two immiscible liquids without visible separation.

According to a preferred embodiment of the damping medium, it can be provided that the mixture is free of fillers, preferably solid additives.

A filler as a solid component of a damping medium can, on the one hand, often fail to achieve the desired shear behavior and, on the other hand, have negative effects on the damping medium or a damper containing the damping medium.

Furthermore, protection is sought for:
a damper with such a damping medium,
a fitting with such a damper and/or such a damping medium,
an arrangement with such a fitting, and
a method for producing such a damping medium.

For the sake of completeness, throughout the present description, the numerical words such as one, two, three and the like, basically only describe the minimum quantity of a feature of the damping medium, the damper, the fitting and the arrangement according to the invention. Individual features or components can of course also be present in larger quantities. Thus, damping media according to the invention can, for example, comprise more than at least one second fluid, dampers according to the invention can comprise more than one damping housing, one piston and/or at least one damping chamber, fittings according to the invention can comprise more than one damping device with more than one damper, arrangements according to the invention can comprise more than at least one first structure, at least one second structure and/or a fitting, etc. In this sense, for example, the numeral “one”, “two”, etc., is to be understood as meaning at least one, at least two, etc, as long as it is reasonable.

### BRIEF DESCRIPTION OF THE DRAWINGS

Further details and advantages of the invention will be explained in greater detail below with reference to the drawings, in which:

FIGS. 1 to 5 show different views of an exemplary embodiment of a damper;

FIGS. 6 to 10 show different views of an exemplary embodiment of a fitting with a damper,

FIGS. 11 and 12 show an exemplary embodiment of an arrangement with a fitting in a retracted and an extended position,

FIGS. 13 to 15 show different shear curves of a first fluid, a second fluid, a reference fluid and a mixture of the first fluid and the second fluid, and

FIG. 16 shows a block diagram of a method for producing a damping medium in the form of a mixture.

### DETAILED DESCRIPTION OF THE INVENTION

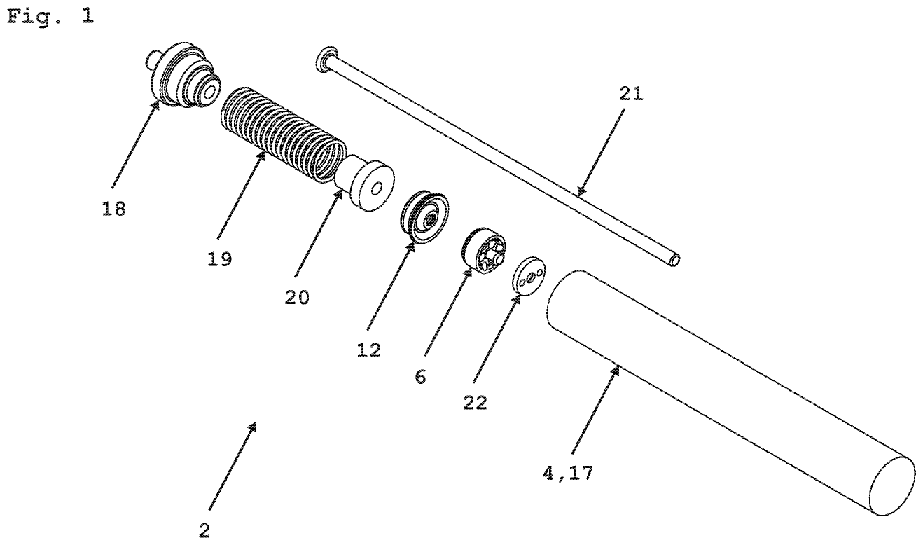

FIGS. 1, 2, 3, 4 and 5 show a damper 2 for a fitting 3, preferably a furniture fitting, wherein the damper 2 has a damper housing 4, at least one damping chamber 5 for receiving a damping medium 1 and a piston 6 movable relative to the damper housing 4 in the damping chamber 5, wherein the damping medium 1 according to the invention is provided in the at least one damping chamber 5, preferably wherein the at least one damping chamber 5 is sealed with at least one seal 12, particularly preferably made of acrylonitrile butadiene rubber NBR.

FIG. 1 shows an exploded view of the damper 2.

As shown in FIG. 1, the damper 2 can comprise a damping housing 4 in the form of a cylinder 17, a cylinder cover 18, a spring element 19, a spring end 20, a seal 12, a piston 6, a piston rod 21 and a piston disc 22.

The spring element 19 can be arranged between the cylinder cover 18 and the spring end 20. The piston rod 21 can run from the outside into the damping housing 4 and be guided through holes in the cylinder cover 18, the spring end 20 and the seal 12 to the piston 6. At one end of the piston rod 21, which is located inside the damping housing 4,17 during the operating state, the piston 6 can be attached to a piston disc 22.

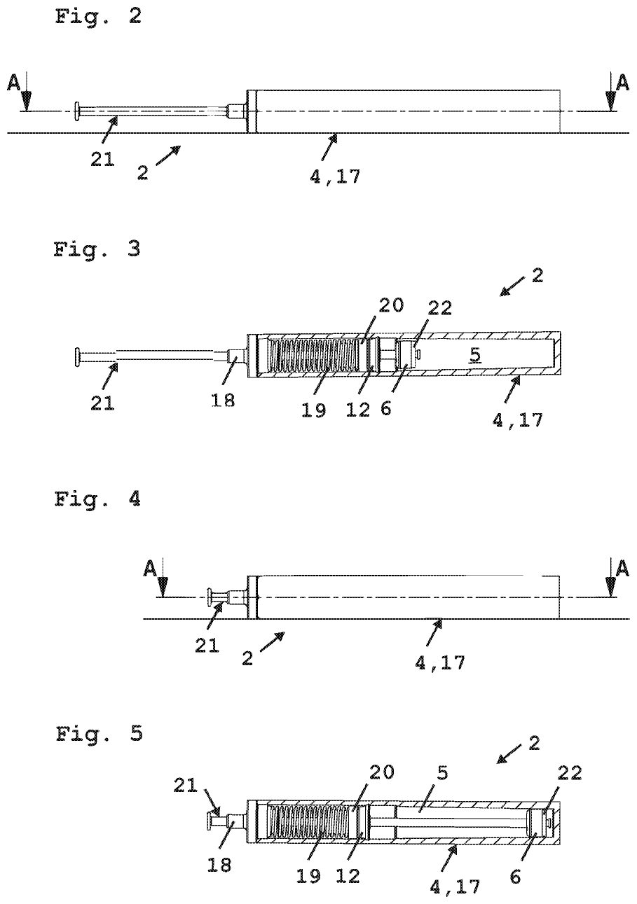

FIG. 2 shows a side view of the damper 2 from FIG. 1, with the piston 6 together with piston rod 21 in the extended state.

FIG. 3 shows a sectional view of the damper 2 from FIG. 3.

As shown in FIG. 3, a damping chamber 5 can be provided inside the damper 2, specifically inside the damping housing 4 and the cylinder 17, in which the damping medium 1 can be located. The damping chamber 5 can be bounded on one side by the seal 12 and on the remaining sides by the cylindrical and closing inner wall of the cylinder 17. Within the damping chamber 5 and surrounded by the damping medium 1, the piston 6 can move either towards the seal 12 or towards the end of the cylinder 17 opposite the seal 12.

FIG. 4 shows a side view of the damper 2 from FIG. 1, with the piston 6 in the retracted state.

FIG. 5 shows a sectional view of the damper 2 from FIG. 4.

In contrast to FIG. 3, the spring element 19 is more compressed in the retracted state. This is because, during the transition of the piston 6 together with piston rod 21 from the extended state (FIGS. 2 and 3) to the retracted state (FIGS. 4 and 5), an overpressure is generated in the damping chamber 5, which can be absorbed via the spring element 19.

FIG. 3 shows that when the piston 6 begins to move into the retracted position, specifically when the piston 6 moves to the right, the damping medium 1 can flow laterally between the piston 6 and the cylindrical inner wall of the cylinder 17. It is not apparent in FIG. 3 that the damping medium 1 can also flow through two holes in the piston 6 and the piston disc 22. The holes of the piston 6 and the piston disc 22 are visible in FIG. 1.

The cylindrical inner wall of the cylinder 17 can be conical from approximately the middle of the cylinder length, as shown in FIGS. 3 and 5. This makes it increasingly difficult for the damping medium 1 to flow between piston 6 and the cylindrical inner wall during the movement of the piston 6 from the extended to the retracted state. The flow of the damping medium 1 through the holes of the piston 6 and the piston disc 22, however, is always unimpeded.

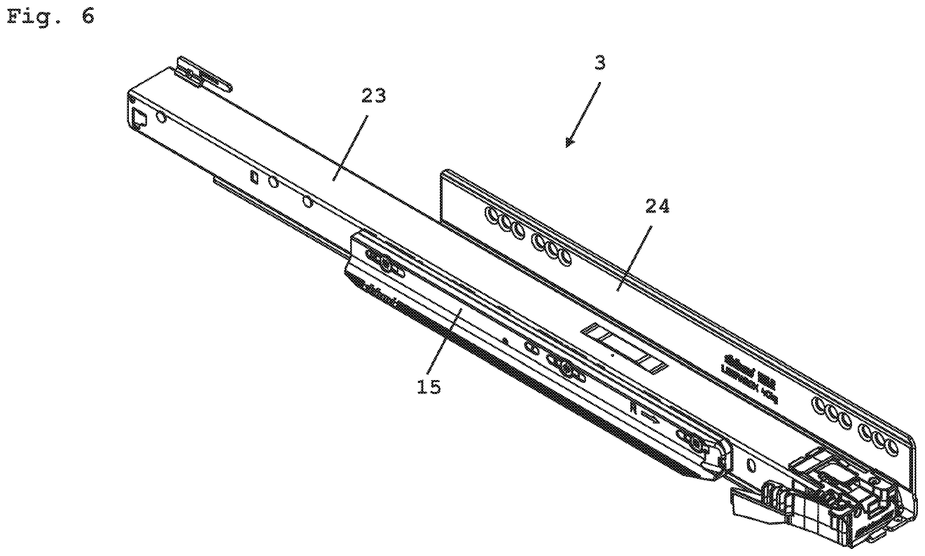

FIGS. 6, 7, 8, 9 and 10 show a fitting 3, preferably a furniture fitting, for the movable mounting of at least one first, preferably movable, structure 13 relative to at least one second, preferably stationary, structure 14, wherein the fitting 3 has a damping device 15 with a damper 2 for the damped movement of the at least one first structure 13 relative to the at least one second structure 14, wherein the damper 2 has a damping medium 1 according to the invention and/or the damper 2 is designed for receiving a damping medium 1 according to the invention.

A structure can be, for example, a window, a door, a chest of drawers, a wardrobe, and the like.

A movable structure could be, for example, a glass window, a house/room door, a drawer, a cupboard door, a flap, and the like.

A fixed structure could be, for example, a window frame, a door frame, a wall, a furniture body, and the like.

FIG. 6 shows a perspective view of the fitting 3 in the form of a pull-out guide.

The pull-out guide can have a first, preferably movable, rail 23, drawer rail, a second, preferably fixed, rail 24, body rail, and a damping device 15. The damping device 15 can dampen a movement of the first rail 23 relative to the second rail 24.

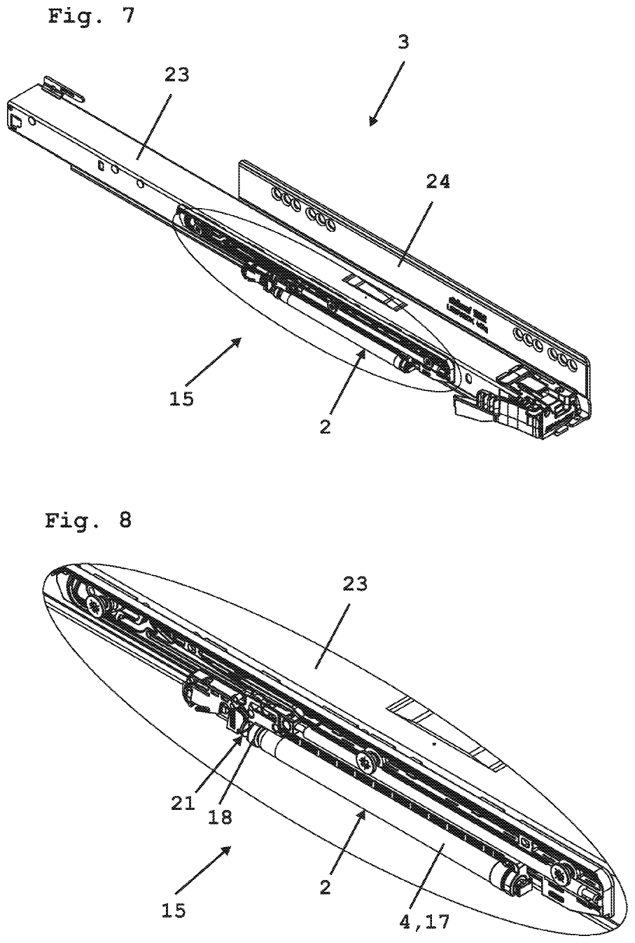

FIG. 7 shows a perspective view of the fitting 3 from FIG. 6, with a cover element of the damping device 15 hidden. Thus, the damper 2 of the damping device 15 can be easily identified.

FIG. 8 shows a detailed view of the fitting 3 from FIG. 7, in which the damper 2 is particularly visible.

The damper 2 can be attached to the second rail 25, the body rail of the pull-out guide, and can be operatively connected to the first rail 24 via the piston rod 21. In the case shown, the piston 6 and therefore also the piston rod 21 are in the retracted state.

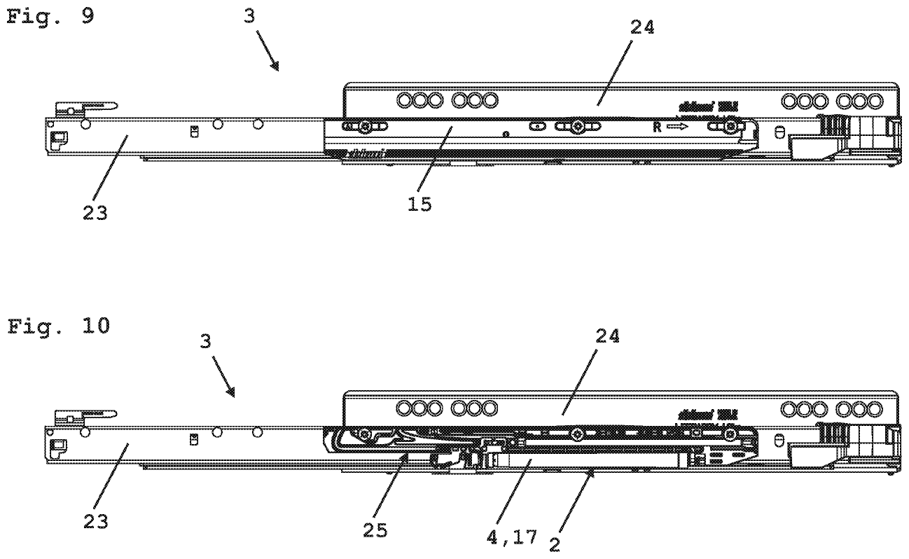

FIG. 9 shows a side view of the fitting 3 from FIG. 6.

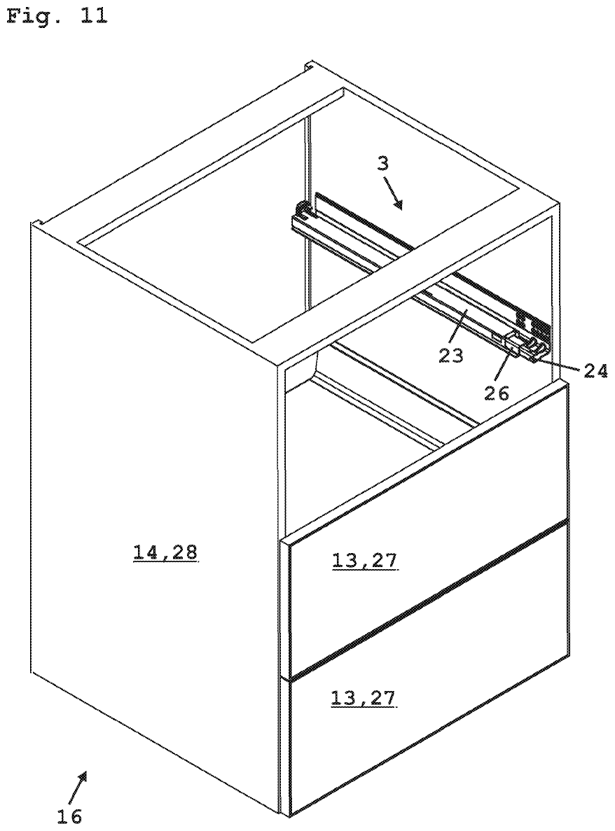

FIG. 10 shows a side view of the fitting 3 from FIG. 7.

What has been said so far about damper 2 applies analogously to damping device 15.

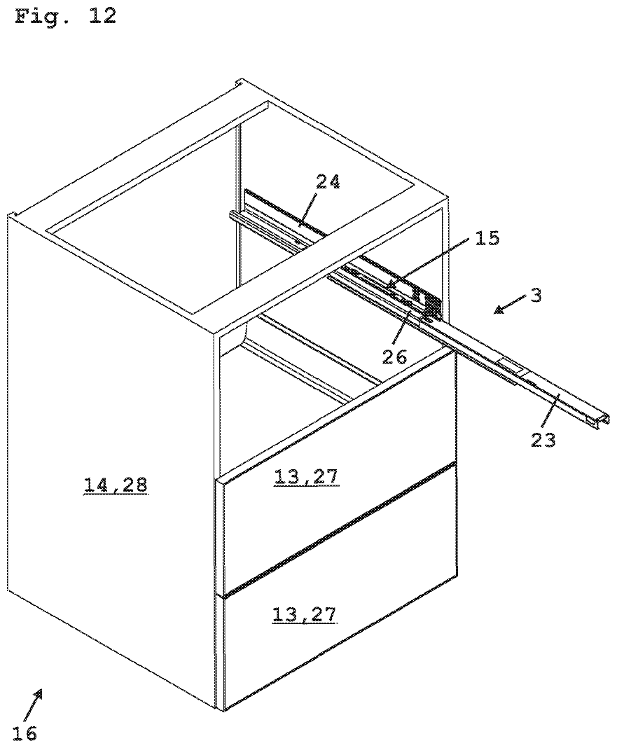

FIGS. 11 and 12 show an arrangement 16, preferably furniture, comprising:
at least one first, preferably movable, structure 13,
at least a second, preferably fixed, structure 14 and
a fitting 13, preferably a furniture fitting, for the movable mounting of the at least one first structure 13 relative to the at least one second structure 14,
   wherein the fitting 3 is designed for receiving a damping medium 1 according to the invention.

FIG. 11 shows a perspective view of the arrangement 16 in the form of a furniture. The first, preferably movable, structures 13 are in this case designed as drawers 27. The second, preferably fixed, structure 14 is in this case designed as a furniture body 28. The top drawer 27 of arrangement is hidden for better illustration.

In FIG. 11 a fitting 3 can be seen on a side wall of the furniture body 28, which is in the form of a pull-out guide and is in the retracted state.

FIG. 12 shows a perspective view of the arrangement 16 in the form of the furniture from FIG. 11, with the fitting 3 in the extended state. This reveals a damping device 15, which is arranged between the first rail 23 and the side wall of the furniture body 28.

The statements made so far regarding fitting 3 apply analogously to arrangement 16.

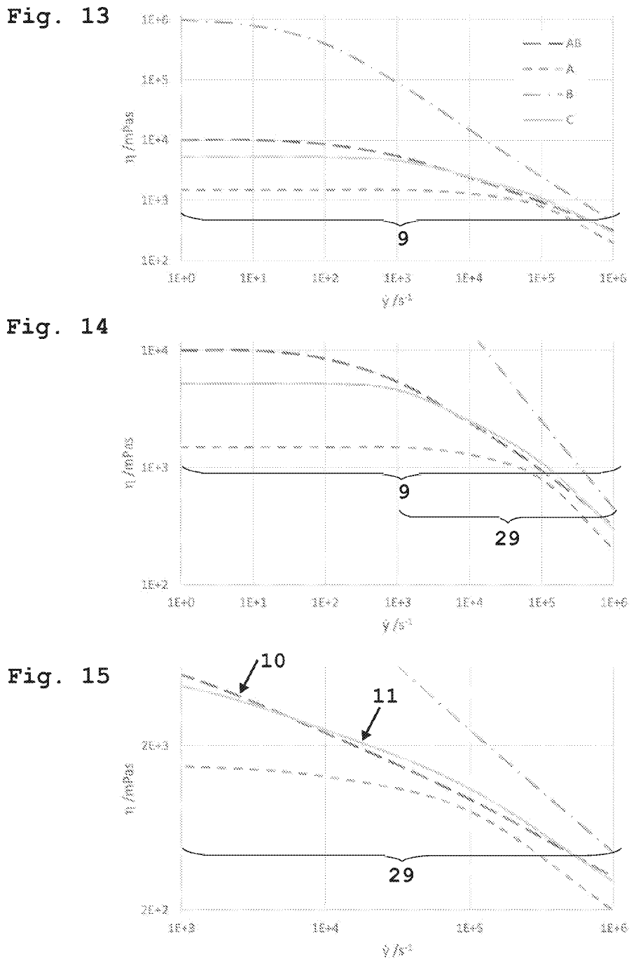

FIGS. 13, 14 and 15 show a diagram with four shear curves of four substances, where the X-axis represents the shear rate \dot{y} in s⁻¹ and the Y-axis represents the viscosity η in mPas. The X-axis and the Y-axis are in a logarithmic scale.

The four different substances in FIGS. 13 to 15 are the pure substance A (line with short dashes), the pure substance B (dash-dot line), the pure substance C (solid line) and the mixture AB (line with long dashes).

FIG. 13 shows a shear rate range from 1 s⁻¹ to 1,000,000 s⁻¹ and a viscosity range from 100 mPas to 1,000,000 mPas. FIG. 14 shows the same shear rate range but a narrower viscosity range from 100 mPas to 10,000 mPas. FIG. 15 shows a narrower shear rate range from 1,000 s⁻¹ to 1,000,000 s⁻¹ and a narrower viscosity range from 200 mPas to approximately 2,500 mPas.

The mixture AB from FIGS. 13 to 15 is a damping mixture 1, namely a damping medium 1 for use in a damper 2 for a fitting 3, preferably a furniture fitting, wherein the damper 2 comprises a damper housing 4, at least one damping chamber 5 for receiving the damping medium 1, and a piston 6 movable relative to the damper housing 4 within the damping chamber 5, wherein the damping medium 1 is a mixture, wherein the mixture comprises a first fluid 7, preferably a first liquid, and at least a second fluid 8, preferably a second liquid, wherein the at least one second fluid 8 in the form of a pure substance prior to the mixing with the first fluid 7 has a, preferably 10 to 200,000 times, particularly preferably 100 to 10,000 times, higher zero viscosity than the first fluid 7 in the form of a pure substance prior to the mixing with the at least one second fluid 8 under otherwise identical conditions.

The following applies to the embodiment shown in FIGS. 13 to 15:
The pure substance A is the first fluid 7 and has a zero viscosity η_{A}⁰ of 1,500 mPas.
The pure substance B is the second fluid 8 and has a zero viscosity η_{B}⁰ of 1,000,000 mPas.
The mixture AB consists of pure substance A and pure substance B and has a zero viscosity η_{AB}⁰ of 10,000 mPas. The mass fraction of pure substance A is 80% and the mass fraction of pure substance B is 20%.
The pure substance C is a reference fluid and has a zero viscosity η_{A}⁰ of 5,200 mPas.

According to a preferred embodiment of the damping medium 1, it can be provided that the first fluid 7 has a zero viscosity between 100 mPas and 1,500 mPas, preferably between 200 mPas and 1,000 mPas, and/or the at least one second fluid 8 has a zero viscosity between 500,000 mPas and 20,000,000 mPas, preferably between 1,000,000 mPas and 16,000,000 mPas.

This has the technical effect that the zero viscosity of the damping medium, specifically the mixture AB, can be adjusted over a wide range, specifically between 1,500 mPas and 1,000,000 mPas.

According to a preferred embodiment of the damping medium, it can be provided that the viscosity of the mixture:
at low shear rates, preferably up to 100 s⁻¹, is greater than 8,000 mPas, and
at high shear rates, preferably from 1,000 s⁻¹ up to 100,000 s⁻¹, particularly preferably from 10,000 s⁻¹ up to 100,000 s⁻¹, and under otherwise identical conditions is less than 8,000 mPas.

According to a preferred embodiment of the damping medium, it can be provided that the viscosity of the mixture:
at low shear rates, preferably up to 100 s⁻¹, is greater than 3,000 mPas, and
at high shear rates, preferably from 1,000 s⁻¹ up to 100,000 s⁻¹, particularly preferably from 10,000 s⁻¹ up to 100,000 s⁻¹, and under otherwise identical conditions is less than 3,000 mPas.

According to a preferred embodiment of the damping medium, it can be provided that the viscosity of the mixture:
at low shear rates, preferably up to 100 s⁻¹, is greater than 500 mPas, and
at high shear rates, preferably from 1,000 s⁻¹ up to 100,000 s⁻¹, particularly preferably from 10,000 s⁻¹ up to 100,000 s⁻¹, and under otherwise identical conditions is less than 500 mPas.

This has the technical effect that the shear behavior of the damping medium, specifically the mixture AB, corresponds to a higher viscosity fluid at low shear rates but to a lower viscosity fluid at high shear rates.

According to a preferred embodiment of the damping medium, it can be provided that the viscosity of the mixture at shear rates within the application range 9 of the damping medium 1, preferably within the effective application range 29 of the damping medium 1, particularly preferably from 1,000 s⁻to 100,000 s⁻¹, most preferably from 10,000 s⁻¹ to 100,000 s⁻¹, is smaller, preferably by a factor of 2 to 10, than the viscosity of the mixture at lower shear rates outside the application range 9, preferably outside the effective application range 29, particularly preferably up to 100 s⁻¹, and under otherwise identical conditions.

The application range is the range of shear rate in which the damping medium is used. The application range can extend from 1 s⁻¹ to 100,000,000 s⁻¹, although the application range is usually 1 s⁻¹ to 1,000,000 s⁻¹.

Instead of the application range, an effective application range can also be used. The effective application range is that range of shear rate in which at least the damping effect of the damping medium occurs to a predominant extent, and/or that range of shear rate in which the gradient, i.e. the slope, of the function of viscosity as a function of shear rate is not equal to zero.

The damping effect may be particularly necessary at higher shear rates, for example to dampen a closing movement of a drawer 27, see FIGS. 11 and 12. If a drawer 27 is closed with momentum by a user, a relatively high shear rate may initially act on the damping medium 1, at which a low-viscosity shear behavior may be desirable. Shortly before reaching the closed end position of drawer 27, the closing speed of the drawer may be lower due to a braking effect, which also results in a lower shear rate than before. During this phase of closing the drawer 27, a highly viscous shear behavior of the damping medium 1 may be desired.

According to a preferred embodiment of the damping medium:
a shear curve of the mixture 10, which results from a function of viscosity as a function of shear rate, approaches, as the shear velocity increases, a shear curve of a pure substance 11 with a zero viscosity that is lower than the zero viscosity of the mixture, and/or
a shear curve of the mixture 10, which is derived from a function of viscosity as a function of the shear rate, intersects, at least once, as the shear rate increases, a shear curve of a pure substance 11 with a zero viscosity that is lower than the zero viscosity of the mixture.

The shear curve of mixture 10 is shown in FIG. 15 as the shear curve of mixture AB (line with long dashes). The shear curve of pure substance 11 is shown in FIG. 15 as the shear curve of pure substance C, which can be used as a reference fluid (solid line).

FIGS. 14 and 15 show that the shear curve 10 of the mixture AB (line with long dashes) intersects the shear curve of the pure substance C (solid line) twice. This means that the mixture AB has a higher viscosity before the first intersection point, a lower viscosity until the second intersection point, and a higher viscosity again after the second intersection point than the pure substance C.

The technical effect resulting from the fact that the shear curve of the mixture 10 approaches the shear curve of the pure substance 11 and/or intersects the shear curve of the pure substance 11 at least once is as follows:

A damping medium 1, specifically the mixture AB, can thus be provided which has a higher viscosity in a certain, preferably lower, shear rate range and a lower viscosity in another, preferably higher, shear rate range than another damping medium, specifically the pure substance 11, the reference fluid C. In this way, the damping medium 1, the mixture AB, is better adapted to the respective application than the other damping medium, reference fluid C.

According to a preferred embodiment of the damping medium 1, the mixing ratio of the first fluid 7 to at least one second fluid 8 is between 1:1 and 25:1, preferably between 2:1 and 7:1, particularly preferably between 3:1 and 5:1.

In a preferred embodiment, the mixture 10 may contain at least equal amounts of the first fluid 7 and the at least one second fluid 8, or more of the first fluid 7 than of the at least one second fluid 8, in other words, more of the thinner fluid than of the thicker fluid.

In a preferred exemplary embodiment, the mixing ratio of the first fluid 7 to at least one second fluid 8 may be 4:1. This has the technical effect that, within the limits defined by the first fluid 7 and the at least one second fluid 8, the zero viscosity of the damping medium 1 and the shear behavior can be flexibly adjusted.

According to a preferred embodiment of the damping medium 1, the first fluid 7 and/or the at least one second fluid 8 is a silicone oil, preferably a polydimethylsiloxane (PDMS), a modified polydimethylsiloxane and/or a copolymer of polydimethylsiloxane.

The choice of material of the first fluid 7 and of the at least one second fluid 8 allows the limits of the adjustable zero viscosity and the shear behavior of the damping medium 1 to be determined.

The choice of material, in conjunction with the mixing ratio of the first fluid 7 and the at least one second fluid 8, enables individual adaptation of the zero viscosity and the shear behavior of the damping medium 1. Thus, the approximation and/or intersection of the shear curve of the damping medium 1 with the shear curve of a reference fluid C can also be flexibly adjusted. For example, the intersection point of the shear curves of the damping medium 1 and the reference fluid C can be generated at a preferred shear rate and/or at a preferred viscosity.

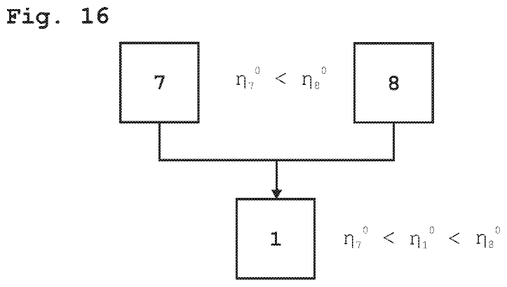

FIG. 16 shows a block diagram of a process for producing a damping medium 1 with the following process steps:
providing a first fluid 7, preferably a first liquid, in the form of a pure substance with a first zero viscosity,
providing at least one second fluid 8, preferably a second liquid, in the form of a pure substance with a second zero viscosity, wherein the second zero viscosity of the at least one second fluid 8 is higher than the first zero viscosity of the first fluid 7,
combining the first fluid 7 and the at least one second fluid 8 to form a mixture.

In FIG. 16, the first zero viscosity η₇⁰ of the first fluid 7 before being combined with the at least one second fluid 8 is smaller than the second zero viscosity η₈⁰ of the at least one second fluid 8 before being combined with the first fluid 7. After combining, a damping medium 1 in the form of a mixture of the first fluid 7 and the at least one second fluid 8 is produced, wherein the zero viscosity η₁⁰ of the mixture lies between the first zero viscosity η₇⁰ of the first fluid 7 and the second zero viscosity η₈⁰ of the at least one second fluid 8.

### LIST OF REFERENCE NUMERALS

1 damping medium
2 damper
3 fitting
4 damper housing
5 damping chamber
6 piston
7 first fluid
8 second fluid
9 application range
10 shear curve of the mixture
11 shear curve of a pure substance
12 seal
13 first structure
14 second structure
15 damping device
16 arrangement
17 cylinder
18 cylinder cover
19 spring element
20 spring end
21 piston rod
22 piston disc
23 first rail
24 second rail
25 mounting plate
26 intermediate rail
27 drawer
28 furniture body
29 effective application range

1. A damping medium for use in a damper for a fitting, preferably a furniture fitting, wherein the damper comprises a damper housing, at least one damping chamber for receiving the damping medium, and a piston movable relative to the damper housing within the damping chamber, wherein the damping medium is a mixture, wherein the mixture comprises a first fluid, preferably a first liquid, and at least a second fluid, preferably a second liquid, wherein the at least one second fluid in the form of a pure substance prior to the mixing with the first fluid has a, preferably 10 to 200,000 times, particularly preferably 100 to 10,000 times, higher zero viscosity than the first fluid in the form of a pure substance prior to the mixing with the at least one second fluid under otherwise identical conditions.

2. The damping medium according to claim 1, wherein the mixture is a solution or a dispersion, preferably an emulsion.

3. The damping medium according to claim 1, wherein the mixture is free of fillers, preferably solid additives.

4. The damping medium according to claim 1, wherein the first fluid has a zero viscosity between 100 mPas and 1,500 mPas, preferably between 200 mPas and 1,000 mPas, and/or the at least one second fluid has a zero viscosity between 500,000 mPas and 20,000,000 mPas, preferably between 1,000,000 mPas and 16,000,000 mPas.

5. The damping medium according to claim 1, wherein the viscosity of the mixture:
at low shear rates, preferably up to 100 s⁻¹, is greater than 8,000 mPas, and
at high shear rates, preferably from 1,000 s⁻¹ up to 100,000 s⁻¹, particularly preferably from 10,000 s⁻¹ up to 100,000 s⁻¹, and under otherwise identical conditions is less than 8,000 mPas.

6. The damping medium according to claim 1, wherein the viscosity of the mixture:
at low shear rates, preferably up to 100 s⁻¹, is greater than 3,000 mPas, and
at high shear rates, preferably from 1,000 s⁻¹ up to 100,000 s⁻¹, particularly preferably from 10,000 s⁻¹ up to 100,000 s⁻¹, and under otherwise identical conditions is less than 3,000 mPas.

7. The damping medium according to claim 1, wherein the viscosity of the mixture:
at low shear rates, preferably up to 100 s⁻¹, is greater than 500 mPas, and
at high shear rates, preferably from 1,000 s⁻¹ up to 100,000 s⁻¹, particularly preferably from 10,000 s⁻¹ up to 100,000 s⁻¹, and under otherwise identical conditions is less than 500 mPas.

8. The damping medium according to claim 1, wherein the viscosity of the mixture at shear rates within the application range of the damping medium, preferably within the effective application range of the damping medium, particularly preferably from 1,000 s⁻¹ up to 100,000 s⁻¹, most particularly preferably from 10,000 s⁻¹ up to 100,000 s⁻¹, is lower, preferably by a factor of 2 to 10, than the viscosity of the mixture at lower shear rates outside the application range, preferably outside the effective application range, particularly preferably up to 100 s⁻¹, and under otherwise identical conditions.

9. The damping medium according to claim 1, wherein:
a shear curve of the mixture, which is derived from a function of viscosity as a function of the shear rate, approaches, as the shear rate increases, a shear curve of a pure substance with a zero viscosity that is lower than the zero viscosity of the mixture, and/or
a shear curve of the mixture, which is derived from a function of viscosity as a function of the shear rate, intersects, at least once, as the shear rate increases, a shear curve of a pure substance with a zero viscosity that is lower than the zero viscosity of the mixture.

10. The damping medium according to claim 1, wherein the mixing ratio of the first fluid to the at least one second fluid is between 1:1 and 25:1, preferably between 2:1 and 7:1, particularly preferably between 3:1 and 5:1.

11. The damping medium according to claim 1, wherein the first fluid and/or the at least one second fluid is a silicone oil, preferably a polydimethylsiloxane (PDMS), a modified polydimethylsiloxane and/or a copolymer of polydimethylsiloxane.

12. A damper for a fitting, preferably a furniture fitting, wherein the damper comprises a damper housing, at least one damping chamber for receiving a damping medium, and a piston movable relative to the damper housing within the damping chamber, wherein the damping medium is provided in the at least one damping chamber according to claim 1, preferably wherein the at least one damping chamber is sealed with at least one seal, particularly preferably made of acrylonitrile-butadiene rubber (NBR).

13. A fitting, preferably a furniture fitting, for the movable mounting of at least one first, preferably movable, structure relative to at least one second, preferably stationary, structure, wherein the fitting has a damping device with a damper for damped movement of the at least one first structure relative to the at least one second structure, wherein the damper has the damping medium according to claim 1.

14. An arrangement, preferably furniture, comprising:
at least a first, preferably movable, structure,
at least a second, preferably fixed, structure, and
the fitting according to claim 12, preferably a furniture fitting, for the movable mounting of the at least one first structure relative to the at least one second structure.

15. A method for producing a damping medium according to claim 1, comprising:
providing a first fluid, preferably a first liquid, in the form of a pure substance with a first zero viscosity,
providing at least one second fluid, preferably a second liquid, in the form of a pure substance having a second zero viscosity, wherein the second zero viscosity of the at least one second fluid is higher than the first zero viscosity of the first fluid, and
combining the first fluid and the at least one second fluid to form a mixture.
